(19) United States
(12) Patent Application Publication
(10) Pub. No.: US 2021/0243277 A1
(43) Pub. Date: Aug. 5, 2021

(54) SEAMLESS APP DOWNLOAD

(71) Applicant: Sirius XM Connected Vehicle Services Inc., Irving, TX (US)

(72) Inventors: Rob Patterson, Irving, TX (US); Sean Gibbons, Irving, TX (US); Simon Whitcher, Irving, TX (US); Alex Omelas, Irving, TX (US); Carl Sobeski, Irving, TX (US); David Hayes, Irving, TX (US); Sergey Kalachev, Irving, TX (US); Rene Ruffles, Irving, TX (US)

(21) Appl. No.: 17/164,260

(22) Filed: Feb. 1, 2021

Related U.S. Application Data
(60) Provisional application No. 62/967,944, filed on Jan. 30, 2020.

(51) Int. Cl. H04L 29/08; H04W 4/14; H04W 4/40; G06K 7/10; G06Q 30/02; G06F 8/61; H04W 12/06

(52) U.S. Cl. CPC H04L 67/34; H04W 4/14; H04W 4/40; G06Q 20/127; G06Q 30/0271; G06F 8/61; H04W 12/06; G06K 7/10297

(57) ABSTRACT

A system and method for seamless app download is described herein. The system and method described herein make it as easy as possible for a customer to download an app on their phone from the car and securely login to that app from the car. A method described herein involves a process where a generic or personalized audio ad is delivered to the listener to motivate them to upgrade their plan to listen to that channel.

### CROSS REFERENCE TO RELATED APPLICATIONS

This applications claims the benefit of U.S. Provisional Application No. 62/967,944, filed Jan. 30, 2020, the contents of all of which are hereby incorporated by reference herein.

### FIELD OF INVENTION

This application is in the field of satellite radio.

### BACKGROUND

Surfacing, or having an individual review an advertisement for an app in-vehicle, may ordinarily require the user to pull over the car, manually search for the app, download it, and then login. A substantial lag may occur between the user wanting or needing the app and actually obtaining it during travel. A system and method described herein may simplify this by allowing a driver to download the app in a few possible ways.

Today's user experience when they tune to a channel that is not in their subscription plan they don't have much of a reason to upgrade their subscription plan.

When a user tunes to a channel that is not part of their audio subscription plan, they may hear a generic or personalized clip with an introduction from the producer, some sample content from that channel, and a call to action to get the user to upgrade or subscribe to the service.

### SUMMARY OF INVENTION

A system and method for seamless app download is described herein. The system and method described herein make it as easy as possible for a customer to download an app on their phone from the car and securely login to that app from the car.

The method described herein involves a process where a generic or personalized audio ad is delivered to the listener to motivate them to upgrade their plan to listen to that channel.

### BRIEF DESCRIPTION OF THE DRAWINGS

FIG. 1 is an example of a SiriusXM™ radio screen including a get the app link;

FIG. 2 is an example of the user's phone receiving a direct, actionable link;

FIG. 3 is an example of the user's phone being directed to download the SiriusXM™ Radio app;

FIG. 4 is an example of the user's phone utilizing the SiriusXM™ app;

FIG. 5 is an example method for seamlessly downloading an app in-vehicle; and

FIG. 6 is an example method for seamlessly upgrading a subscription plan.

### DETAILED DESCRIPTION OF THE DRAWINGS

Surfacing, or having an individual review an advertisement for an app in-vehicle, may ordinarily require the user to pull over the car, manually search for the app, download it, and then login. The system and method described herein may simplify this by allowing a driver to download the app in a few possible ways. For example, the user may press a single button on their radio to receive a text message or may wave their phone over a sensor to download the app.

In the case of an in-vehicle radio, it has been determined that conversion from an all access trial to purchasing the app increases when subscribers listen both in and out of the car. With 360L (one of Sirius XM Radio Inc.'s latest in-vehicle technology platforms), users may be prompted, via a direct, actionable, link (while in the car), to get the app and listen outside the car.

In a first example, a user (or driver) may press a single button on the radio to have a Short Message Service (SMS) text message transmitted to them with a deferred deep link to download the mobile app. This link may allow the user to be directed right to the Apple™ App Store or Google™ Play store. The driver may push a button that may transmit a request over Internet Protocol (IP) to a server. A security token linked to that user may then be created. A SMS request may be routed to be transmitted to the user's mobile phone. When the vehicle is turned off, the vehicle may transmit a message over IP that the car is turned off so the request for the SMS message to be transmitted to the user is made. The user may click on the link on their phone and may then be routed to the appropriate app store to download the requested app.

In a second example, the user may wave their phone over a Near Field Communication (NFC) sensor in the vehicle to download the mobile app. This link may allow the user to be directed right to the Apple™ App Store or Google™ Play Store. After the user downloads the app onto their mobile phone, they may wave their phone over the NFC sensor again to login to the mobile app as a secure token that is personalized to the user is transmitted over IP, through the radio, and to the NFC transceiver.

If the app is installed and launched while attached to the vehicle, for example, via BlueTooth™, WI-FI, NFC, or cable, a token may be passed to share the all access trial directly with the phone app.

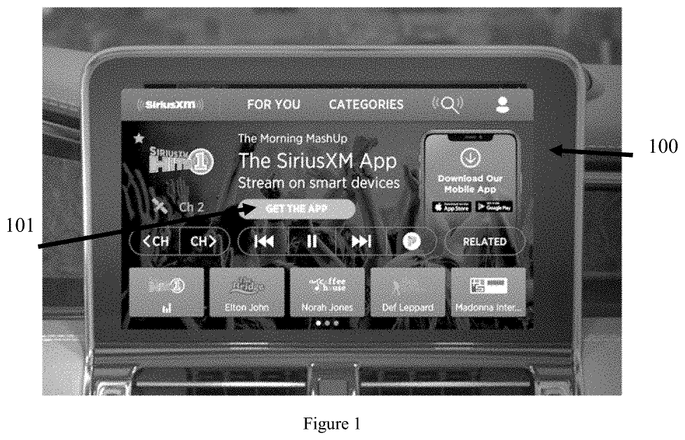

FIG. 1 is an example of a SiriusXM™ radio screen including a “get the app” link. While a user is listening to SiriusXM™ radio in the car, a prompt 101 may appear on the radio screen 100 to enable the user to get the app. As described above, the user may either push the prompt 101 on the radio or wave their phone over a NFC sensor.

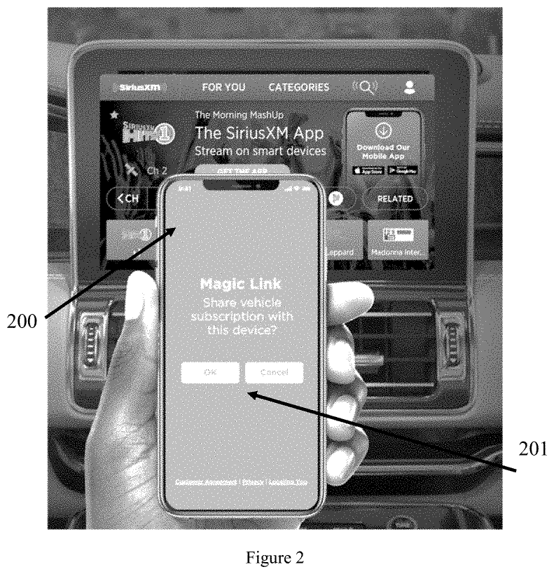

FIG. 2 is an example of the user's phone receiving a direct, actionable link. Once the user pushes the prompt, a link 201 may appear on their phone 200 to be redirected to the Apple™ App Store or the Google™ Play Store.

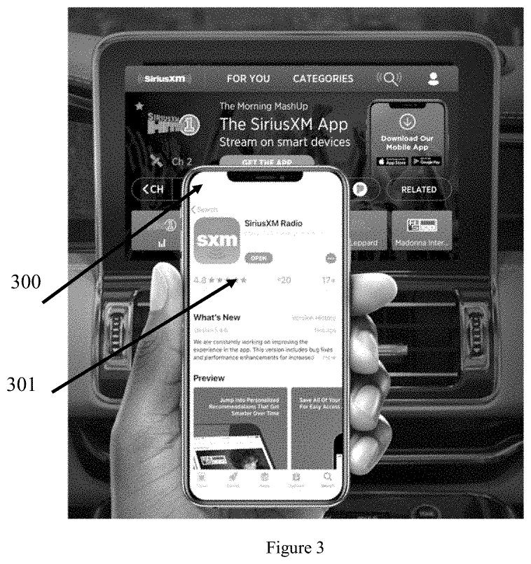

FIG. 3 is an example of the user's phone being directed to download the SiriusXM™ Radio app. After the user accepts the link on their phone 300 they may be redirected to the Apple™ App Store or the Google™ Play Store for purchasing the SiriusXM™ Radio app 301.

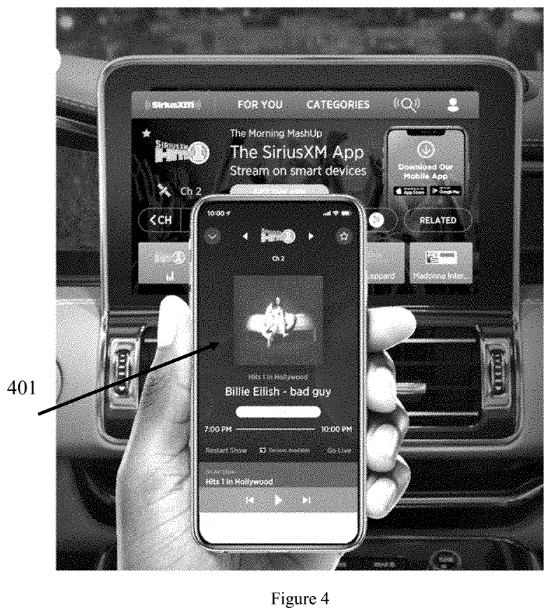

FIG. 4 is an example of the user's phone utilizing the SiriusXM™ app. After the user successfully downloads the SiriusXM™ app 401, they may successfully begin to stream music on their phone. The user is able to utilize the same all access trial that is being offered in vehicle, on their phones.

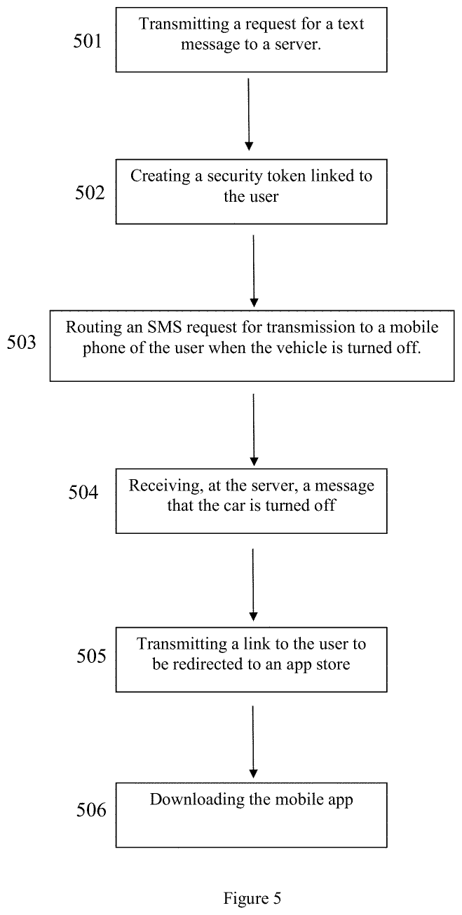

FIG. 5 is an example method for seamlessly downloading an app in-vehicle. The user may transmit a request for a text message to a server 501. The request may be made when the user presses a button on a radio screen. A security token, linked to the user, may then be created 502. An SMS request may be routed for transmission to a mobile phone of the user when the vehicle is turned off 503. The server may then receive a message that the car is turned off 504. A link may then be transmitted to the user to be redirected to an app store 505. The user may then download a mobile app 506.

In another embodiment, when a user tunes to a channel that is not part of their audio subscription plan, they may hear a generic or personalized clip with an intro from the producer, some sample content from that channel, and a call to action to get the user to upgrade or subscribe to the service. The method described herein may involve a process where a generic or personalized audio ad is delivered to the listener to motivate them to upgrade their plan to listen to that channel.

When a user tunes to a channel that is not in their subscription plan, a request may be made over IP from the car to a server that will deliver a Uniform Resource Locator (URL) that may stream an audio clip. The audio clip may play a generic or personalized intro, some short highlight clips that have been previously selected for that particular channel, and a call to action to upgrade or subscribe to this channel. For example, the audio clip may say “Hi Mark, I know how much you like football and boy have we got something for you . . . ”

There may also be a contextual action button on the radio, mobile app, web, or home device that may take the user to a conversion screen to subscribe or provide a way to easily connect to a call center to upgrade their subscription plan (as previously described herein).

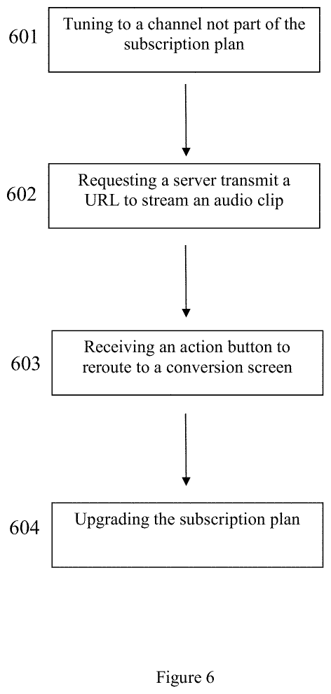

FIG. 6 is an example method for seamlessly upgrading a subscription plan. A user may tune to a channel that is not part of their subscription plan 601. A request may be transmitted to a server for a URL to stream an audio clip 602. The audio clip may play a generic or personalized intro, some short highlight clips that have been previously selected for that particular channel, and a call to action to upgrade or subscribe to this channel. The user may receive an action button, rerouting the user to a conversion screen 603. The user may then upgrade the subscription plan 604.

What is claimed:

1. A method for seamlessly downloading an app in-vehicle, the method comprising:
receiving a request for a text message at a server;
creating a security token linked to a user in response to receiving the request for a text message;
routing an SMS request for transmission to a mobile phone of the user;
receiving a message that the car is turned off; and
transmitting a the SMS request to the user, wherein SMS request includes a link that redirects the user to download a mobile app.

2. The method of claim 1, wherein the request for a text message is in response to the user pressing a button on a radio screen.

3. The method of claim 1, wherein the user is redirected to an app store.

4. The method of claim 1, wherein the request is transmitted to the server over Internet Protocol (IP).

5. A method for seamlessly downloading an app in-vehicle, the method comprising:
waving a mobile phone over a sensor in a vehicle to download a mobile app;
receiving a link on the mobile phone;
clicking the received link;
routing the user to an app store; and
downloading the mobile app.

6. The method of claim 5, wherein the sensor is a Near Field Communication (NFC) sensor.

7. The method of claim 6, further comprising:
waving the mobile phone over the sensor a second time to login to the mobile app using a secure token transmitted over Internet Protocol (IP), through the radio, and to an NFC transceiver.

8. The method of claim 7, where in the secure token is personalized to the user.

9. The method of claim 5, wherein on a condition that the app is installed and launched while attached to the vehicle, a token is passed to share an all access trial directly with the mobile app.

10. A method for seamlessly upgrading a subscription plan, the method comprising:
tuning to a channel that is not part of a subscription plan of a user;
transmitting a request to a server for a Uniform Resource Locator (URL) to stream an audio clip;
receiving the audio clip, wherein the audio clip is a generic or personalized audio advertisement;
receiving an action button, wherein the action button reroutes the user to a conversion screen; and
upgrading the subscription plan.

11. The method of claim 10, wherein the audio clip includes a personalized intro, short highlight clips, and a call to action.

12. The method of claim 10, wherein the conversion screen includes a link to subscribe or a way to easily connect to a call center to upgrade.

13. The method of claim 10, wherein the request is transmitted to the server over Internet Protocol (IP).
